(19) United States
(12) Patent Application Publication
(10) Pub. No.: US 2026/0368242 A1
(43) Pub. Date: Nov. 19, 2026

(54) TANGIBLE OBJECT INTEGRATED IMMERSIVE SHARING AND GENERATION SYSTEM

(71) Applicant: Kyle Schreiner, Coeur D Alene, ID (US)

(72) Inventor: Kyle Schreiner, Coeur D Alene, ID (US)

(21) Appl. No.: 19/676,543

(22) Filed: May 13, 2026

Related U.S. Application Data
(60) Provisional application No. 63/806,246, filed on May 15, 2025.

(51) Int. Cl. G06F 16/438; G06F 16/483; G06K 7/14

(52) U.S. Cl. CPC G06F 16/4393; G06F 16/483; G06K 7/1417

(57) ABSTRACT

Apparatus and associated methods relate to a system including at least one unique physical identifier having a machine-readable element configured to be scanned by a user computing device, the at least one physical identifier physically coupled to a tangible object, such that scanning the machine-readable code with the user device causes the user device to retrieve an object profile associated with the tangible object. The tangible object may, for example, include a taxidermy mount. The object profile may, for example, include digital content (e.g., multimedia content) associated with one or more events corresponding to the tangible object. The object profile may, for example, include metadata associated with one or more events corresponding to the tangible object. Various embodiments may advantageously generate and maintain an evolving digital profile persistently linked to a tangible object.

### CROSS-REFERENCE TO RELATED APPLICATIONS

This application is a nonprovisional application and claims the benefit of U.S. application Ser. No. 63/806,246, titled “TAXIDERMY-INTEGRATED IMMERSIVE MEMORY SHARING AND GENERATION SYSTEM,” filed by Kyle Schreiner on May 15, 2025.

### TECHNICAL FIELD

Various embodiments relate generally to physical object and digital experience linking systems.

### BACKGROUND

Physical objects in the real world are frequently subjected to events, conditions, and interactions throughout their lifecycle. For example, objects may be transported, handled, stored, modified, used, inspected, damaged, repaired, or transferred between different users or locations. In many environments, information relating to such experiences may be collected, monitored, or associated with the objects.

Physical-digital experience linking systems generally relate to technologies that associate physical objects and real-world experiences with digital platforms. Such systems may use electronic devices, communication networks, software applications, and identifiers to connect interactions involving physical items with corresponding digital experiences.

### SUMMARY

Apparatus and associated methods relate to a system including at least one unique physical identifier having a machine-readable element configured to be scanned by a user computing device, the at least one physical identifier physically coupled to a tangible object, such that scanning the machine-readable code with the user device causes the user device to retrieve an object profile associated with the tangible object. The tangible object may, for example, include a taxidermy mount. The object profile may, for example, include digital content (e.g., multimedia content) associated with one or more events corresponding to the tangible object. The object profile may, for example, include metadata associated with one or more events corresponding to the tangible object. Various embodiments may advantageously generate and maintain an evolving digital profile persistently linked to a tangible object.

Various embodiments may achieve one or more advantages. For example, some embodiments may establish a persistent linkage between a tangible object and a digital profile by anchoring the digital record to a machine-readable physical identifier that is physically coupled to the object. Some embodiments may, for example, advantageously establish a stable digital identity of a tangible object independent of user devices. Some implementations may, for example, advantageously interpret metadata and context automatically to reduce the use of manual curation or editing of content. Some embodiments may, for example advantageously support digital experiences that can evolve over time as new events, content, and metadata are added, while remaining tied to the same physical object. Some implementations may, for example, advantageously enable dynamic updating of a digital experience presentation tied to a tangible object.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts an exemplary object-integrated multi-media story system (OIMMSS) employed in an illustrative use-case scenario.

FIG. 2 is a block diagram depicting an exemplary OIMMSS on a user device.

FIG. 3 is a flowchart illustrating an exemplary method of setting up an object profile via a corresponding machine-readable code linked to the object profile.

FIG. 4 is a flowchart illustrating exemplary operations of an OIMMSS.

FIGS. 5A-5B depict a flowchart illustrating an exemplary method correlating an object profile with a physical identifier and generating a digital experience presentation.

Like reference symbols in the various drawings indicate like elements.

### DETAILED DESCRIPTION OF ILLUSTRATIVE EMBODIMENTS

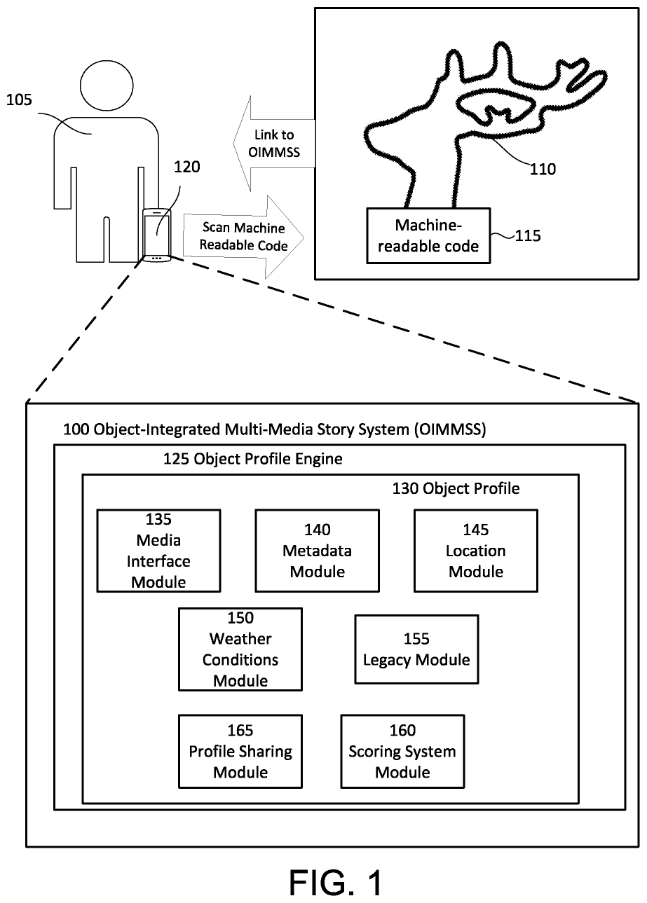

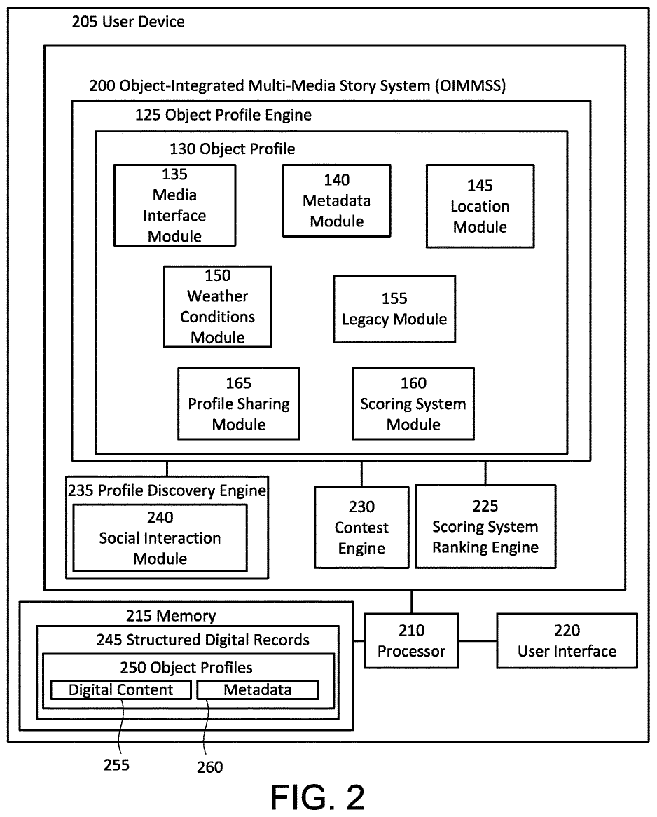

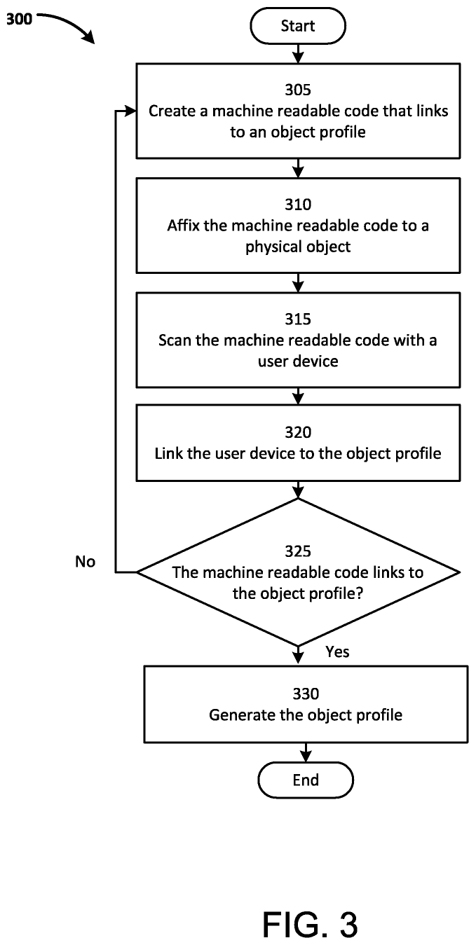

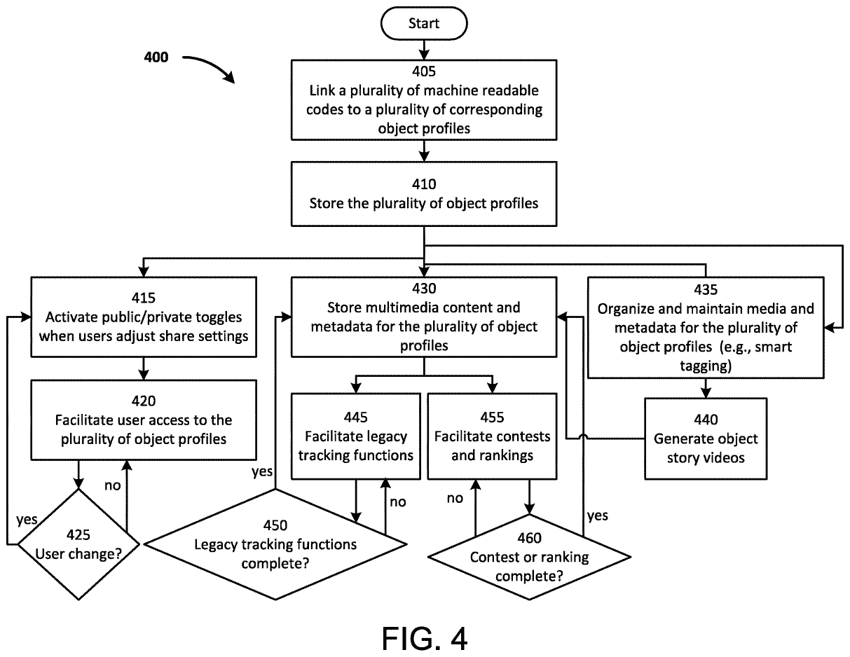

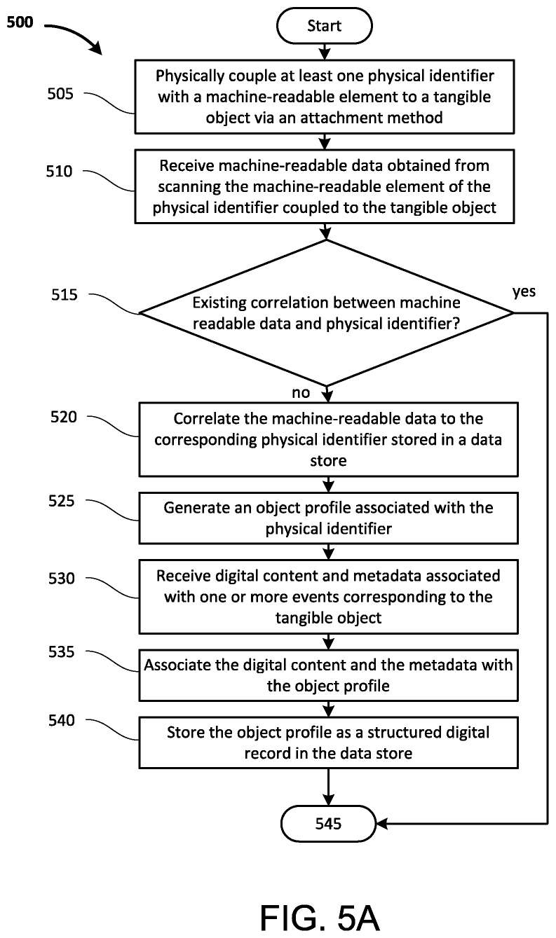

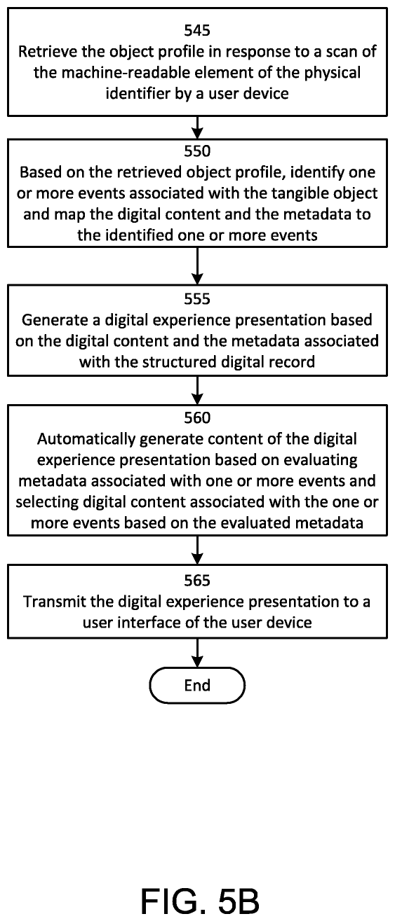

To aid understanding, this document is organized as follows. First, to help introduce discussion of various embodiments, an object-integrated multi-media story system (OIMMSS) is introduced with reference to FIGS. 1-2. Second, that introduction leads into a description with reference to FIG. 3 of an exemplary method of setting up a object profile via a corresponding machine-readable code linked to the object profile. Third, with reference to FIG. 4, exemplary operations of a OIMMSS are described. Fourth, with reference to FIGS. 5A-5B, an exemplary method of correlating an object profile with a physical identifier and generating a digital experience presentation is introduced. Finally, the document discusses further embodiments, exemplary applications and aspects relating to an OIMMSS.

FIG. 1 depicts an exemplary object-integrated multi-media story system (OIMMSS 100) employed in an illustrative use-case scenario. The OIMMSS 100 may, for example, include a cloud-based platform. The OIMMSS 100 may, for example, include a hosted platform that stores digital assets.

The illustrative use-case scenario depicted in FIG. 1 includes a user 105. The user 105 provides a tangible object 110. By way of example, and not limitation, the tangible object 110 may include a taxidermy mount (e.g., shoulder mounts, skulls, full-body mounts, euro mounts, waterfowl panels). By way of example, and not limitation, the tangible object 110 may include a collectible item. By way of example, and not limitation, the tangible object 110 may include a historical artifact. By way of example, and not limitation, the tangible object 110 may include a legacy item. By way of example, and not limitation, the tangible object 110 may include hunting equipment. By way of example, and not limitation, the tangible object 110 may include sporting gear.

The tangible object 110 includes a machine-readable code 115 affixed to the tangible object 110. The machine readable code 115 may, for example, include a quick response (QR) code. The machine readable code 115 may, for example, include a near field communication (NFC). The machine readable code 115 may, for example, include a Radio-Frequency Identification (RFID). The machine readable code 115 may, for example, include a Bluetooth low energy (BLE) tag.

By way of example, and not limitation, the machine readable code 115 may be releasably coupled to the tangible object 110 via magnetic fasteners. By way of example, and not limitation, the machine readable code 115 may be operatively coupled to the tangible object 110 via mechanical fixation (e.g., push pins, tacks, screws, rivets). By way of example, and not limitation, the machine readable code 115 may be operatively coupled to the tangible object 110 via adhesive-based attachment using pressure sensitive adhesives (e.g., 3M-type adhesives, epoxies). By way of example, and not limitation, the machine readable code 115 may be embedded to the tangible object 110 within the form, structure, or material of the object itself (e.g., within foam, backing, or internal cavities).

The user 105 may, for example, provide a user device 120. The user device 120 may, for example, include a computing device. The user device 120 may, for example, include a mobile phone. The user device 120 may, for example, include a desktop interface. The user device 120 may, for example, be configured to scan the machine readable code 115. The machine readable code 115 may, for example, link the user device 120 to the OIMMSS 100.

The OIMMSS 100 may, for example, include an object profile engine 125. The user device 120 scanning the machine readable code 115 may, for example, link the user device 120 to the OIMMSS 100 and prompt the object profile engine 125 to generate an object profile 130 that corresponds to the machine readable code 115.

The object profile 130 may, for example, include a media interface module 135. The media interface module 135 may, for example, enable the user 105 to upload media to the object profile 130. The media may, for example, include photos from events associated with the tangible object 110. The media may, for example, include videos from events associated with the tangible object 110. The media may, for example, include voice recordings providing user 105 commentary of the tangible object 110. The media interface module 135 may, for example, store the media uploaded to the object profile 130. The media interface module 135 may, for example, incorporate artificial intelligence to auto-generate an object story video from the uploaded media. The media interface module 135 may, for example, incorporate artificial intelligence to smart tag the uploaded media to automatically organize and categorize the uploaded media.

The object profile 130 may, for example, include a metadata module 140. The metadata module 140 may, for example, retrieve metadata from inputs provided by a user 105. For example, the user 105 may manually enter metadata describing one or more events associated with the tangible object 110. The metadata may, for example, include temporal information and location information associated with an event corresponding to the tangible object 110. The metadata may, for example, include descriptive information related to characteristics or attributes of the tangible object 110. The metadata may, for example, include information identifying individuals or entities involved in creation, modification, or handling of the tangible object 110. The metadata may, for example, include information describing tools, techniques, or conditions associated with the one or more events.

Media uploaded to the media interface module 135 may, for example, include embedded metadata that the OIMMSS 100 may extract. The metadata module 140 may, for example, store metadata associated with the object profile 130. The metadata module 140 may, for example, operate in conjunction with the media interface module 135 to automatically generate a digital experience presentation from uploaded media. The metadata module 140 may further automatically tag, organize, and categorize metadata to support structured storage and retrieval of object-associated content.

The object profile 130 may, for example, include a location module 145. The location module 145 may, for example, automatically retrieve geographic location information associated with one or more events corresponding to the tangible object 110 based on metadata. For example, the user device 120 may include location-determining functionality that the location module 145 may access to capture geographic coordinates associated with an event involving the tangible object 110. If the user 105 uploads photos or videos associated with an event to the media interface module 135, the location module 145 may, for example, extract geolocation data embedded in the media files. The user 105 may, for example, manually enter location information into the location module 145. The location module 145 may, for example, store geographic location information associated with the one or more events in the object profile 130.

The object profile 130 may, for example, include a weather conditions module 150. The weather conditions module 150 may, for example, automate the collection of the weather during the events associated with the tangible object 110. For example, the weather conditions module 150 may retrieve the date, time, and location of the events provided by the user 105, and query weather databases (e.g., Weather. com) to retrieve historical weather data for the specified location. The weather conditions module 150 may, for example, store the retrieved historical weather data.

The object profile 130 may, for example, include a legacy module 155. The legacy module 155 may, for example, enable the user 105 to tag family members or connect family members profiles within the OIMMSS 100. The legacy module 155 may, for example, advantageously enable the user 105 to link the object profile 130 with those of family members (e.g., father-son or grandchild connections), creating a shared hunting history across generations.

For tangible objects 110 that are display objects or preserved physical artifacts, the legacy module 155 may, for example, organize tangible objects within the OIMMSS 100 based on user-defined criteria (e.g., size, category, origin, date, or personal significance) and display the tangible objects in a dedicated section of the user's 105 object profile 130. The legacy module 155 may, for example, enable the user 105 to curate a personal and/or shared collection showcasing particularly significant objects. The legacy module 155 may further provide templates and tools for generating “legacy pages” associated with tangible objects. In some embodiments, the tangible objects may comprise taxidermy mounts associated with hunting activities, and the legacy pages may include historical records, narratives, or commemorative information related to hunting events. In other embodiments, the legacy pages may document non-hunting-related history, provenance, or significance associated with the tangible objects and the user 105.

The object profile 130 may, for example, include a scoring system module 160. The scoring system module 160 may, for example, calculate scores, ratings, or other evaluative metrics associated with the tangible object 110 based on user-provided inputs and standardized criteria. In some embodiments, the scoring system module 160 may apply formulas to quantify attributes of the tangible object. For example, where the tangible object 110 comprises a taxidermy mount associated with a hunting activity, the scoring system module 160 may calculate scores based on standardized hunting-related criteria, such as Boone & Crockett criteria or Pope & Young criteria. In other embodiments, the scoring system module 160 may evaluate non-hunting-related objects based on alternative standards, measurements, or classification frameworks appropriate to the type, use, or significance of the tangible object.

The object profile 130 may, for example, include a public sharing module 165. The public sharing module 165 may, for example, enable the user 105 to toggle between public and private sharing of the object profile 130. Public profiles may, for example, be visible to all users of the OIMMSS 100. Private profiles may, for example, restrict visibility to selected users of the OIMMSS 100.

The user device 205 includes a processor 210 communicatively coupled to a memory 215. The memory 215 may, for example, store structured digital records 245 accessible by the processor 210. The structured digital records 245 may, for example, include one or more object profiles 250. Each object profile 250 may, for example, include digital content 255 and metadata 260 associated with one or more events corresponding to the tangible object 110.

The processor 210 may, for example, retrieve the digital content 255 and metadata 260 from the memory 215. The processor 210 may, for example, communicatively couple the OIMMSS 200, such that execution of program instructions by the processor 210 enables interaction with functional modules of the OIMMSS 200. In some embodiments, the processor 210 may transmit retrieved digital content 255 and metadata 260 from the memory 215 to the OIMMSS 200 to support generation, updating, or regeneration of a digital experience presentation corresponding to one or more object profiles 250.

The processor 210 may, for example, communicably couple to a user interface 220. For example, the processor 210 may retrieve data structures associated with the OIMMSS 200 and transmit output generated by the OIMMSS 200 to the user interface 220. The user interface 220 may be configured to present the digital experience presentation to the user 105, including visual, audio, or textual representations derived from the digital content 255 and metadata 260 stored within the object profile 250.

The OIMMSS 200 includes a scoring system ranking engine 225. The scoring system ranking engine 225 may, for example, enable users of the OIMMSS 200 to compare attributes, scores, and/or evaluative metrics associated with a tangible object (e.g., tangible object 110) against corresponding attributes, scores, and/or metrics associated with other tangible objects stored within the OIMMSS 200. Comparisons may, for example, be filtered or organized according to user-defined criteria, such as geographic region, category, classification, or other descriptive parameters associated with the tangible objects. The scoring system ranking engine 225 may, for example, retrieve scoring data from the scoring system module 160 and generate ranked results based on the retrieved scoring data. The rankings may, for example, be presented according to selected comparison dimensions, such as region, category, classification, or other criteria. In some embodiments, where the tangible objects comprise taxidermy mounts associated with hunting activities, the scoring system ranking engine 225 may compare and rank the tangible objects based on standardized hunting-related scoring criteria (e.g., species-based or measurement-based classifications).

The OIMMSS 200 includes a contest engine 230. The contest engine 230 may, for example, organize comparative activities, challenges, or evaluations based on defined criteria associated with tangible objects stored within the OIMMSS 200. The contest engine 230 may, for example, enable a user of the OIMMSS 200 to submit an object profile 130 for inclusion in such a comparative activity. The contest engine 230 may, for example, utilize evaluative data, scores, or metrics retrieved from the scoring system module 160 to rank object profiles participating in the comparative activity. In some embodiments, the contest engine 230 may support user participation through mechanisms such as selection, feedback, or voting to determine outcomes or recognition levels. The contest engine 230 may further generate indicators of recognition, such as digital badges, rankings, status markers, or other distinctions associated with object profiles. The contest engine 230 may, for example, include a voting features where the OIMMSS 200 users may vote for the winner of the contest. The contest engine 230 may, for example, generate digital badges, rankings, or other forms of recognition.

The OIMMSS 200 includes a profile discovery engine 235. The profile discovery engine 235 may, for example, include a search bar such that user may search for object profiles (e.g., object profile 130) based on various criteria. The criteria may, for example, include tangible object characteristics (e.g., species of a taxidermy mount). The criteria may, for example, include location of an event. The criteria may, for example, include date of an event. The criteria may, for example, include trophy score or ranking. The criteria may, for example, include weather conditions. Profiles shared publicly may, for example, be searchable by other users of the OIMMSS 200.

The profile discovery engine 235 includes a social interaction module 240. The social interaction module 240 may, for example, enable users to leave comments on other object profiles (e.g., object profile 130). The social interaction module 240 may, for example, enable users to leave a like on other object profiles (e.g., object profile 130). Popular profiles with high likes may, for example, be featured in community highlights or contests by the profile discovery engine 235. The social interaction module 240 may, for example, enable users to tag a user on another user's object profile (e.g., object profile 130). Tags may, for example, be used to link related trophies (e.g., father-son hunts or multi-generational stories).

FIG. 3 is a flowchart illustrating an exemplary method 300 of setting up an object profile via a corresponding machine readable code linked to the object profile. In a step 305, a machine readable code (e.g., machine readable code 115) is created that links to an object profile (e.g., object profile 130). In a step 310, the machine readable code is affixed to a physical object (e.g., tangible object 110). In a step 315, a user scans the machine readable code with a user device (e.g., user device 120). In a step 320, scanning the machine readable code links the user device to the object profile. In a step 325, a checkpoint is reached, where the user checks if the machine readable code links to the object profile of the tangible object. If the user decides no, the machine readable code does not link to the object profile of the taxidermy mount, then the method 300 reverts to step 305. If the user decides yes, the machine readable code links to the object profile of the taxidermy mount, then the method 300 proceeds to step 330. In a step 330, the user creates the object profile. The user may, for example, create the object profile in a substantially similar manner as the user 105 described in the illustrative use-case scenario with reference to FIG. 1.

FIG. 4 is a flowchart illustrating exemplary operations 400 of a OIMMSS (e.g., OIMMSS 100 and OIMMSS 200). The operations 400 include in a step 405, linking a plurality of machine readable codes (e.g., machine readable code 115) to a plurality of corresponding object profiles (e.g., object profile 130). In a step 410, the operations 400 include storing the plurality of object profiles on the OIMMSS. The OIMMSS may, for example select from or simultaneously do the operations 400 in steps 415, 430, and 455.

In step 415, the operations 400 include activating public/private toggles when users of the OIMMSS adjust their share settings. For example, the user may adjust their share setting to private. For example, the user may adjust their share setting to public. Public profiles may, for example, be visible to all users of the OIMMSS. Private profiles may, for example, restrict visibility to selected users of the OIMMSS. In step 420, the operations 400 include facilitating user access to the plurality of object profiles. The OIMMSS may, for example facilitate user access to the plurality of object profiles in a manner substantially as the profile discovery engine 235 as described with reference to FIG. 2. In a step 425, the OIMMSS monitors whether a user changes their share settings. If yes, the operations 400 revert to step 415. If no, the operations 400 revert to step 420.

In a step 430, the operations 400 include storing multimedia content and metadata for the plurality of object profiles. For example, the operations 400 may store multimedia content and metadata in a substantially similar manner as described with reference to the media interface module 135 and metadata module 140. In a step 435, the operations 400 include organizing and maintaining media and metadata for the plurality of object profiles. For example, the operations 400 may include smart tagging the uploaded media and metadata to automatically organize and categorize the uploaded media and metadata. The operations 400 may, for example, revert from step 435 to step 430 to store the smart tagged and categorized media and metadata in the object profiles. In a step 440, the operations 400 may, for example, auto-generate a hunt story video from the uploaded media and metadata in a substantially similar manner as is described with reference to the media interface module 135 and metadata module 140. The operations 400 may, for example, revert from step 440 to step 430 to store the auto-generated hunt story video in the object profile.

Step 430 of the operations 400 may, for example, proceed to a step 445. In a step 445, the operations 400 facilitate legacy tracking functions. The legacy tracking functions may, for example, include functions that are substantially similar to the functions described with reference to the legacy module 155. In a step 450, the operations 400 include deciding whether the legacy tracking functions are complete. If not, the operations 400 revert to step 445 to continue facilitating the legacy tracking functions. If yes, the operations 400 revert to step 430 to the store the data created from the legacy tracking functions in the object profiles.

Step 430 of the operations 400 may, for example, proceed to a step 455. In a step 455, the operations 400 facilitate contests and rankings. For example, the operations 400 may facilitate contests and rankings in a substantially similar manner as was described with reference to the scoring system module 160, scoring system ranking engine 225, and contest engine 230. In a step 450, the operations 400 include deciding whether the contest or ranking is complete. If no, the operations 400 revert to step 455 to facilitate contests or rankings until the contest or ranking is complete. If yes, the operations 400 revert to step 430 the store the data from the contest or ranking in the object profiles.

FIGS. 5A-5B depict a flowchart illustrating an exemplary method 500 correlating an object profile (e.g., object profile 250) with a physical identifier and generating a digital experience presentation.

In a step 505, at least one physical identifier with a machine-readable element (e.g., machine readable code 115) is physically coupled to a tangible object (e.g., tangible object 110) via an attachment method. By way of example, and not limitation, the machine-readable element may include a QR code. By way of example, and not limitation, the machine-readable element may include an NFC element. By way of example, and not limitation, the machine-readable element may include an RFID element. By way of example, and not limitation, the machine-readable element may include a BLE element.

By way of example, and not limitation, the tangible object may include a taxidermy mount. By way of example, and not limitation, the tangible object may include a collectible item. By way of example, and not limitation, the tangible object may include an historical artifact. By way of example, and not limitation, the tangible object may include a legacy object (e.g., an object passed from one generation to the next). By way of example, and not limitation, the tangible object may include sporting gear. By way of example, and not limitation, the tangible object may include a preserved physical object.

The physical identifier may be coupled to the tangible object via an attachment method. For example, the attachment method may include magnetic integration. Magnetic integration may include a magnet-based system in which a magnetic element is positioned beneath a surface of the tangible object or within an internal form, enabling the physical identifier to be securely retained while allowing repositioning based on visibility, accessibility, or aesthetic preference. This approach further enables modular relocation of the physical identifier without damaging the tangible object. For example, a magnet-based system may position the machine-readable element beneath a hide or within a form of a taxidermy mount using paired magnetic components, allowing repositioning of the identifier without damaging the tangible object while maintaining scannability.

For example, the attachment method may include mechanical fixation. Mechanical fixation may include fasteners such as push pins, tacks, screws, or rivets configured to secure the physical identifier directly to a surface, backing structure, or internal form of the tangible object. Such fixation may be employed where permanent or semi-permanent attachment is desired.

For example, the attachment method may include adhesive-based attachment. Adhesive-based attachment may include the use of pressure-sensitive adhesives, epoxies, or other bonding agents to affix the physical identifier to the tangible object or an adjacent mounting surface. This approach may provide a low-profile attachment while maintaining sufficient retention for scanning.

For example, the attachment method may include embedded placement. Embedded placement may include positioning the physical identifier within a form, cavity, or material structure of the tangible object, including concealed or semi-concealed configurations. Such placement allows the physical identifier to remain protected while preserving scannability.

For example, the attachment method may include auxiliary mounting structures. Auxiliary mounting structures may include housings, brackets, clips, straps, stitching, or secondary carriers configured to hold the physical identifier and attach to the tangible object. These structures may provide flexibility in positioning and replacement of the physical identifier.

In a step 510, the OIMMSS receives machine-readable data obtained from scanning the machine-readable element of the physical identifier coupled to the tangible object. For example, a user device may scan the machine-readable element and transmit encoded identifier data to the OIMMSS via a communication interface (e.g., a wireless network interface such as Wi-Fi, cellular data, Bluetooth, or a wired network interface).

In a step 515, the OIMMSS has reached a decision point to decide whether an existing correlation between the received machine-readable data and a stored physical identifier exists. If the OIMMSS decides no, the method 500 proceeds to step 520. If the OIMMSS decides yes, the method 500 proceeds to step 545. For example, a processor may query structured digital records stored in memory to determine whether the received identifier data already maps to an existing object profile.

In a step 520, the OIMMSS correlates the received machine-readable data to a corresponding physical identifier stored in a data store. For example, an object profile engine may generate and store an association between the decoded identifier value, and a physical identifier record maintained by the OIMMSS. The association may also be stored in a memory module.

In a step 525, the OIMMSS generates an object profile associated with the physical identifier and receives digital content and metadata associated with one or more events corresponding to the tangible object. Digital content may include multimedia content. For example, the digital content may include images. For example, the digital content may include video recordings. For example, the digital content may include audio recordings. Metadata may, for example, include temporal data. Metadata may, for example, include location data. Metadata may, for example, include environmental data. Metadata may, for example, include participant data. Metadata may, for example, include object attributes. Metadata may, for example, include capture parameters. For example, a media interface module and a metadata module may receive and process uploaded media and user-provided metadata associated with events involving the tangible object, such as events related to display, acquisition, modification, or use of the tangible object, including hunting-related events where applicable.

In a step 535, the OIMMSS associates the received digital content and metadata with the object profile. For example, a processor may organize digital content and metadata into structured fields of the object profile stored in memory.

In a step 540, the OIMMSS stores the object profile as a structured digital record. For example, the processor may store the object profile in a memory module as a structured digital records that persists the object profile to enable retrieval independent of user sessions or devices.

In a step 545, the OIMMSS retrieves the object profile in response to a scan of the machine-readable element by a user device. For example, scanning the machine-readable element may prompt the OIMMSS to retrieve the corresponding object profile associated with the physical identifier.

In a step 550, based on the retrieved object profile, the OIMMSS identifies one or more events associated with the tangible object and maps the digital content and metadata to the identified one or more events. For example, a media interface module may analyze digital content and correlate the digital content to the one or more events. For example, a metadata module may analyze temporal and contextual metadata to associate media items with events related to the tangible object.

In a step 555, the OIMMSS generates a digital experience presentation based on the digital content and metadata associated with the structured digital record. For example, a processor may assemble digital content (e.g., visual, audio, textual elements) and metadata (e.g., temporal data, location data, environmental data, participant data, object identification data, and capture parameter data) and transfer the into a media interface module and metadata module to generate a coherent presentation derived from the object profile.

In a step 560, the OIMMSS automatically generates content of the digital experience presentation by evaluating metadata associated with the one or more events and selecting digital content associated with the one or more events based on the evaluated metadata. For example, metadata analysis may be used to automatically sequence, filter, or highlight digital content according to event timing, location, or contextual relevance to produce an event-based narrative.

For example, the OIMMSS may analyze temporal metadata to determine the sequence in which events occurred, spatial metadata to associate digital content with specific locations, and contextual metadata to determine relevance or significance of particular digital content items.

In some embodiments, the OIMMSS may process metadata fields to group digital content according to event boundaries, filter digital content based on predefined (e.g., user-defined or system-defined) criteria, and prioritize digital content based on relevance scores derived from metadata attributes. The OIMMSS may assemble the selected digital content into an ordered multimedia presentation by arranging visual, audio, and textual elements in a sequence that reflects an event-based history of the tangible object.

In this manner, the digital experience presentation may be dynamically generated based on the current state of the object profile, such that changes or additions to metadata or digital content associated with the tangible object result in regeneration of the digital experience presentation without manual editing or reconfiguration.

In a step 565, the OIMMSS transmits the digital experience presentation to a user interface of the user device. For example, the digital experience presentation may be transmitted to a display interface for presentation to a user device. The digital experience presentation may include a structured, event-based multimedia presentation derived from the object profile. For example, the digital experience presentation may include visual elements such as images, video segments, or graphical representations; audio elements such as narration, ambient sound, or recorded commentary; and textual elements such as event descriptions, object attributes, or contextual annotations derived from metadata.

In some embodiments, the digital experience presentation presents the one or more events associated with the tangible object in a coherent sequence, enabling a user to review an event history, timeline, or narrative associated with the tangible object. The digital experience presentation may further include interactive elements. For example, the interactive elements may include navigable timelines. For example, the interactive elements may include selectable media segments. For example, the interactive elements may include expandable metadata views.

The digital experience presentation may, for example, be transmitted to the user interface by the processor as a dynamic presentation that reflects the current state of the object profile, such that updates to digital content or metadata associated with the tangible object result in corresponding updates to the digital experience presentation upon subsequent access.

In the technical field of taxidermy, preserved mounts and display artifacts are physical objects that typically lack any standardized, persistent mechanism for storing, accessing, or updating digital information associated with their provenance, history, or related events. Existing approaches rely on static labels, handwritten records, separate digital files, or personal recollection, which are prone to loss and do not evolve as new information becomes available.

This disconnect between the physical taxidermy mount, and its associated digital information creates technical challenges in data integrity, long-term preservation, and repeatable access across devices. The disclosed OIMMSS addresses these challenges by physically coupling a machine-readable identifier to the taxidermy mount and linking that identifier to a structured, event-based digital object profile. Scanning the identifier retrieves and dynamically generates a digital experience presentation derived from stored digital content and metadata associated with the mount, thereby establishing a persistent, object-specific, and evolving physical-to-digital linkage that remains intact over time and across user devices.

Although various embodiments have been described with reference to the figures, other embodiments are possible.

In some embodiments a OIMMSS (e.g. OIMMSS 100, OIMMSS 200) may, for example, include a digital-only system for scanned field images, without taxidermy mounts. In some implementations, a OIMMSS (e.g. OIMMSS 100, OIMMSS 200) may, for example, include photo-wall plaques without taxidermy mounts. In some embodiments a OIMMSS (e.g., OIMMSS 100, OIMMSS 200) may, for example, include 3D scanning technology to create digital replicas of taxidermy mounts, enabling virtual displays or enhanced multimedia storytelling.

Although an exemplary system has been described with reference to FIGS. 1-2, other implementations may be deployed in other industrial, scientific, medical, commercial, and/or residential applications.

In industrial applications, a OIMMSS (e.g. OIMMSS 100, OIMMSS 200) may, for example, be employed in inventory management or tracking systems. For example, a OIMMSS (e.g. OIMMSS 100, OIMMSS 200) may be integrated with shops' Customer Relationship Management (CRM) systems or inventory tools, streamlining operations and enhancing customer service.

In scientific applications, a OIMMSS (e.g. OIMMSS 100, OIMMSS 200) may, for example, be employed in wildlife research and conservation efforts. For example, researcher may use a OIMMSS (e.g. OIMMSS 100, OIMMSS 200) to document and analyze hunting data, such as species population trends, harvest locations, and environmental conditions contributing to ecological studies and sustainable hunting practices.

In commercial applications, a OIMMSS (e.g. OIMMSS 100, OIMMSS 200) may, for example, be employed in the commercial sector particularly for hunters and taxidermists. For example, a OIMMSS (e.g. OIMMSS 100, OIMMSS 200) could be marketed as a direct-to consumer product or through partnerships with outfitters and taxidermy shops, offering kits, subscription services, and premium features like legacy page creation and automated video production.

In residential applications, a OIMMSS (e.g. OIMMSS 100, OIMMSS 200) may, for example, be employed by users in their homes through creating a digital archive of their trophies, sharing their experiences with family and friends, and passing down multi-generational stories, fostering a deeper connection to their heritage.

In various embodiments, some bypass circuits implementations may be controlled in response to signals from analog or digital components, which may be discrete, integrated, or a combination of each. Some embodiments may include programmed, programmable devices, or some combination thereof (e.g., PLAs, PLDs, ASICs, microcontroller, microprocessor), and may include one or more data stores (e.g., cell, register, block, page) that provide single or multi-level digital data storage capability, and which may be volatile, non-volatile, or some combination thereof. Some control functions may be implemented in hardware, software, firmware, or a combination of any of them.

Computer program products may contain a set of instructions that, when executed by a processor device, cause the processor to perform prescribed functions. These functions may be performed in conjunction with controlled devices in operable communication with the processor. Computer program products, which may include software, may be stored in a data store tangibly embedded on a storage medium, such as an electronic, magnetic, or rotating storage device, and may be fixed or removable (e.g., hard disk, floppy disk, thumb drive, CD, DVD).

Although an example of a system, which may be portable, has been described with reference to the above figures, other implementations may be deployed in other processing applications, such as desktop and networked environments.

Temporary auxiliary energy inputs may be received, for example, from chargeable or single use batteries, which may enable use in portable or remote applications. Some embodiments may operate with other DC voltage sources, such as a 9V (nominal) batteries, for example. Alternating current (AC) inputs, which may be provided, for example from a 50/60 Hz power port, or from a portable electric generator, may be received via a rectifier and appropriate scaling. Provision for AC (e.g., sine wave, square wave, triangular wave) inputs may include a line frequency transformer to provide voltage step-up, voltage step-down, and/or isolation.

Although particular features of an architecture have been described, other features may be incorporated to improve performance. For example, caching (e.g., L1, L2, . . . ) techniques may be used. Random access memory may be included, for example, to provide scratch pad memory and or to load executable code or parameter information stored for use during runtime operations. Other hardware and software may be provided to perform operations, such as network or other communications using one or more protocols, wireless (e.g., infrared) communications, stored operational energy and power supplies (e.g., batteries), switching and/or linear power supply circuits, software maintenance (e.g., self-test, upgrades), and the like. One or more communication interfaces may be provided in support of data storage and related operations.

Some systems may be implemented as a computer system that can be used with various implementations. For example, various implementations may include digital circuitry, analog circuitry, computer hardware, firmware, software, or combinations thereof. Apparatus can be implemented in a computer program product tangibly embodied in an information carrier, e.g., in a machine-readable storage device, for execution by a programmable processor; and methods can be performed by a programmable processor executing a program of instructions to perform functions of various embodiments by operating on input data and generating an output. Various embodiments can be implemented advantageously in one or more computer programs that are executable on a programmable system including at least one programmable processor coupled to receive data and instructions from, and to transmit data and instructions to, a data storage system, at least one input device, and/or at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, which may include a single processor or one of multiple processors of any kind of computer. Generally, a processor will receive instructions and data from a read-only memory or a random-access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including, by way of example, semiconductor memory devices, such as EPROM, EEPROM, and flash memory devices; magnetic disks, such as internal hard disks and removable disks; magneto-optical disks; and CD-ROM and DVD-ROM disks. The processor and the memory can be supplemented by, or incorporated in, ASICs (application-specific integrated circuits).

In some implementations, each system may be programmed with the same or similar information and/or initialized with substantially identical information stored in volatile and/or non-volatile memory. For example, one data interface may be configured to perform auto configuration, auto download, and/or auto update functions when coupled to an appropriate host device, such as a desktop computer or a server.

In some implementations, one or more user-interface features may be custom configured to perform specific functions. Various embodiments may be implemented in a computer system that includes a graphical user interface and/or an Internet browser. To provide for interaction with a user, some implementations may be implemented on a computer having a display device. The display device may, for example, include an LED (light-emitting diode) display. In some implementations, a display device may, for example, include a CRT (cathode ray tube). In some implementations, a display device may include, for example, an LCD (liquid crystal display). A display device (e.g., monitor) may, for example, be used for displaying information to the user. Some implementations may, for example, include a keyboard and/or pointing device (e.g., mouse, trackpad, trackball, joystick), such as by which the user can provide input to the computer.

In various implementations, the system may communicate using suitable communication methods, equipment, and techniques. For example, the system may communicate with compatible devices (e.g., devices capable of transferring data to and/or from the system) using point-to-point communication in which a message is transported directly from the source to the receiver over a dedicated physical link (e.g., fiber optic link, point-to-point wiring, daisy-chain). The components of the system may exchange information by any form or medium of analog or digital data communication, including packet-based messages on a communication network. Examples of communication networks include, e.g., a LAN (local area network), a WAN (wide area network), MAN (metropolitan area network), wireless and/or optical networks, the computers and networks forming the Internet, or some combination thereof. Other implementations may transport messages by broadcasting to all or substantially all devices that are coupled together by a communication network, for example, by using omni-directional radio frequency (RF) signals. Still other implementations may transport messages characterized by high directivity, such as RF signals transmitted using directional (i.e., narrow beam) antennas or infrared signals that may optionally be used with focusing optics. Still other implementations are possible using appropriate interfaces and protocols such as, by way of example and not intended to be limiting, USB 2.0, Firewire, ATA/IDE, RS-232, RS-422, RS-485, 802.11 a/b/g, Wi-Fi, Ethernet, IrDA, FDDI (fiber distributed data interface), token-ring networks, multiplexing techniques based on frequency, time, or code division, or some combination thereof. Some implementations may optionally incorporate features such as error checking and correction (ECC) for data integrity, or security measures, such as encryption (e.g., WEP) and password protection.

In various embodiments, the computer system may include Internet of Things (IoT) devices. IoT devices may include objects embedded with electronics, software, sensors, actuators, and network connectivity which enable these objects to collect and exchange data. IoT devices may be in-use with wired or wireless devices by sending data through an interface to another device. IoT devices may collect useful data and then autonomously flow the data between other devices.

Various examples of modules may be implemented using circuitry, including various electronic hardware. By way of example and not limitation, the hardware may include transistors, resistors, capacitors, switches, integrated circuits, other modules, or some combination thereof. In various examples, the modules may include analog logic, digital logic, discrete components, traces and/or memory circuits fabricated on a silicon substrate including various integrated circuits (e.g., FPGAs, ASICs), or some combination thereof. In some embodiments, the module(s) may involve execution of preprogrammed instructions, software executed by a processor, or some combination thereof. For example, various modules may involve both hardware and software.

In some aspects, the techniques described herein relate to a system including: at least one physical identifier including a machine-readable element and configured to physically couple a tangible object via an attachment method; a data store including a program of instructions and structured digital records, the structured digital records including one or more object profiles, each object profile associated with a respective physical identifier and including: (i) digital content associated with one or more events corresponding to the tangible object; and (ii) metadata associated with the one or more events; and a processor operably coupled to the data store such that, when the processor executes the program of instructions, the processor causes operations to be performed, the operations including: receive machine-readable data obtained from a scan by a user device of the machine-readable element of the physical identifier physically coupled to the tangible object; correlate the machine-readable data to a corresponding physical identifier; retrieve an object profile associated with the physical identifier; based on the retrieved object profile, identify one or more events associated with the tangible object and map the digital content and the metadata to the identified one or more events; generate a digital experience presentation based on the digital content and the metadata associated with the object profile; and transmit the digital experience presentation to a user interface of the user device, such that there is an established persistent physical-to-digital linkage between the digital experience presentation and the tangible object.

In some aspects, the techniques described herein relate to a system, wherein the machine-readable element further includes a quick response (QR) code.

In some aspects, the techniques described herein relate to a system, wherein the attachment method further includes a magnetic coupling system including a magnetic element positioned within the tangible object and a corresponding magnetic element coupled to the physical identifier, the magnetic coupling system being configured to magnetically retain the physical identifier at a selectable location on the tangible object while enabling removal and repositioning of the physical identifier.

In some aspects, the techniques described herein relate to a system, wherein the digital content further includes multimedia content including images, video recordings, and audio recordings.

In some aspects, the techniques described herein relate to a system, wherein the metadata further includes temporal data, location data, environmental data, participant data, object identification data, and capture parameter data.

In some aspects, the techniques described herein relate to a system, wherein the tangible object further includes a taxidermy mount.

In some aspects, the techniques described herein relate to a system, wherein the operations further include: automatically generate content of the digital experience presentation, wherein the content includes a multimedia presentation generated by: (i) evaluating metadata associated with the one or more events; (ii) selecting digital content associated with the one or more events based on the evaluated metadata; (iii) and based on the selected digital content, generating the multimedia presentation corresponding to an event-based history of the tangible object.

In some aspects, the techniques described herein relate to a computer-implemented method performed by at least one processor to establish a persistent physical-to-digital linkage between a tangible object and a digital experience, the method including: receive machine-readable data obtained from scanning a machine-readable element of a physical identifier physically coupled to a tangible object; correlate the machine-readable data to the corresponding physical identifier stored in a data store; generate an object profile associated with the physical identifier; receive digital content and metadata associated with one or more events corresponding to the tangible object; associate the digital content and the metadata with the object profile; store the object profile as a structured digital record in the data store; retrieve the object profile in response to a scan of the machine-readable element of the physical identifier by a user device; based on the retrieved object profile, identify one or more events associated with the tangible object and map the digital content and the metadata to the identified one or more events; generate a digital experience presentation based on the digital content and the metadata associated with the object profile; and transmit the digital experience presentation to a user interface of the user device, such that there is an established persistent physical-to-digital linkage between the digital experience presentation and the tangible object.

In some aspects, the techniques described herein relate to a method, wherein the machine-readable element further includes a quick response (QR) code.

In some aspects, the techniques described herein relate to a method, wherein the digital content further includes multimedia content including images, video recordings, and audio recordings.

In some aspects, the techniques described herein relate to a method, wherein the metadata further includes temporal data, location data, environmental data, participant data, object identification data, and capture parameter data.

In some aspects, the techniques described herein relate to a method, wherein the tangible object further includes a taxidermy mount.

In some aspects, the techniques described herein relate to a method, wherein the method further includes: automatically generate content of the digital experience presentation, wherein the content includes a multimedia presentation generated by: (i) evaluating metadata associated with the one or more events; (ii) selecting digital content associated with the one or more events based on the evaluated metadata; (iii) and based on the selected digital content, generating the multimedia presentation corresponding to an event-based history of the tangible object.

In some aspects, the techniques described herein relate to a computer program product (CPP) including a program of instructions tangibly embodied on a non-transitory computer readable medium wherein, when the instructions are executed on a processor, the processor causes operations to be performed to establish and maintain a persistent physical-to-digital linkage between a tangible object and an evolving digital experience presentation, the operations including: receive machine-readable data obtained from scanning a machine-readable element of a physical identifier physically coupled to a tangible object; correlate the machine-readable data to the corresponding physical identifier stored in a data store; generate an object profile associated with the physical identifier; receive digital content and metadata associated with one or more events corresponding to the tangible object; associate the digital content and the metadata with the object profile; store the object profile as a structured digital record in the data store; retrieve the object profile in response to a scan of the machine-readable element of the physical identifier by a user device; based on the retrieved object profile, identify one or more events associated with the tangible object and map the digital content and the metadata to the identified one or more events; generate a digital experience presentation based on the digital content and the metadata associated with the object profile; transmit the digital experience presentation to a user interface of the user device; wherein physical coupling of the physical identifier to the tangible object enables repeated scanning of the machine-readable element, such that each scan initiates retrieval of the object profile and enables updates of the object profile via receipt and association of digital content and metadata corresponding to one or more events associated with the tangible object, such that there is an established persistent physical-to-digital linkage between the digital experience presentation and the tangible object.

In some aspects, the techniques described herein relate to a CPP, wherein the machine-readable element further includes a quick response (QR) code.

In some aspects, the techniques described herein relate to a CPP, wherein the digital content further includes multimedia content including images, video recordings, and audio recordings.

In some aspects, the techniques described herein relate to a CPP, wherein the metadata further includes temporal data, location data, environmental data, participant data, object identification data, and capture parameter data.

In some aspects, the techniques described herein relate to a CPP, wherein the tangible object further includes a taxidermy mount.

In some aspects, the techniques described herein relate to a CPP, wherein the operations further include: automatically generate content of the digital experience presentation, wherein the content includes a multimedia presentation generated by: (i) evaluating metadata associated with the one or more events; (ii) selecting digital content associated with the one or more events based on the evaluated metadata; (iii) and based on the selected digital content, generating the multimedia presentation corresponding to an event-based history of the tangible object.

In some aspects, the techniques described herein relate to a CPP, wherein the digital experience presentation includes an event-based multimedia narrative based on the object profile, the event-based multimedia narrative including a structured sequence of visual, audio, and textual elements that present the one or more events associated with the tangible object together with contextual information derived from associated metadata.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

What is claimed is:

1. A system comprising:
at least one physical identifier comprising a machine-readable element and configured to physically couple a tangible object via an attachment method;
a data store comprising a program of instructions and structured digital records, the structured digital records comprising one or more object profiles, each object profile associated with a respective physical identifier and comprising: (i) digital content associated with one or more events corresponding to the tangible object; and (ii) metadata associated with the one or more events; and
a processor operably coupled to the data store such that, when the processor executes the program of instructions, the processor causes operations to be performed, the operations comprising:
receive machine-readable data obtained from a scan by a user device of the machine-readable element of the physical identifier physically coupled to the tangible object;
correlate the machine-readable data to a corresponding physical identifier;
retrieve an object profile associated with the physical identifier;
based on the retrieved object profile, identify one or more events associated with the tangible object and map the digital content and the metadata to the identified one or more events;
generate a digital experience presentation based on the digital content and the metadata associated with the object profile; and
transmit the digital experience presentation to a user interface of the user device,
such that there is an established persistent physical-to-digital linkage between the digital experience presentation and the tangible object.

2. The system of claim 1, wherein the machine-readable element further comprises a quick response (QR) code.

3. The system of claim 1, wherein the attachment method further comprises a magnetic coupling system comprising a magnetic element positioned within the tangible object and a corresponding magnetic element coupled to the physical identifier, the magnetic coupling system being configured to magnetically retain the physical identifier at a selectable location on the tangible object while enabling removal and repositioning of the physical identifier.

4. The system of claim 1, wherein the digital content further comprises multimedia content comprising images, video recordings, and audio recordings.

5. The system of claim 1, wherein the metadata further comprises temporal data, location data, environmental data, participant data, object identification data, and capture parameter data.

6. The system of claim 1, wherein the tangible object further comprises a taxidermy mount.

7. The system of claim 1, wherein the operations further comprise:
automatically generate content of the digital experience presentation, wherein the content comprises a multimedia presentation generated by: (i) evaluating metadata associated with the one or more events; (ii) selecting digital content associated with the one or more events based on the evaluated metadata; (iii) and based on the selected digital content, generating the multimedia presentation corresponding to an event-based history of the tangible object.

8. A computer-implemented method performed by at least one processor to establish a persistent physical-to-digital linkage between a tangible object and a digital experience, the method comprising:
receive machine-readable data obtained from scanning a machine-readable element of a physical identifier physically coupled to a tangible object;
correlate the machine-readable data to the corresponding physical identifier stored in a data store;
generate an object profile associated with the physical identifier;
receive digital content and metadata associated with one or more events corresponding to the tangible object;
associate the digital content and the metadata with the object profile;
store the object profile as a structured digital record in the data store;
retrieve the object profile in response to a scan of the machine-readable element of the physical identifier by a user device;
based on the retrieved object profile, identify one or more events associated with the tangible object and map the digital content and the metadata to the identified one or more events;
generate a digital experience presentation based on the digital content and the metadata associated with the object profile; and
transmit the digital experience presentation to a user interface of the user device,
such that there is an established persistent physical-to-digital linkage between the digital experience presentation and the tangible object.

9. The method of claim 8, wherein the machine-readable element further comprises a quick response (QR) code.

10. The method of claim 8, wherein the digital content further comprises multimedia content comprising images, video recordings, and audio recordings.

11. The method of claim 8, wherein the metadata further comprises temporal data, location data, environmental data, participant data, object identification data, and capture parameter data.

12. The method of claim 8, wherein the tangible object further comprises a taxidermy mount.

13. The method of claim 8, wherein the method further comprises:
automatically generate content of the digital experience presentation, wherein the content comprises a multimedia presentation generated by: (i) evaluating metadata associated with the one or more events; (ii) selecting digital content associated with the one or more events based on the evaluated metadata; (iii) and based on the selected digital content, generating the multimedia presentation corresponding to an event-based history of the tangible object.

14. A computer program product (CPP) comprising a program of instructions tangibly embodied on a non-transitory computer readable medium wherein, when the instructions are executed on a processor, the processor causes operations to be performed to establish and maintain a persistent physical-to-digital linkage between a tangible object and an evolving digital experience presentation, the operations comprising:
receive machine-readable data obtained from scanning a machine-readable element of a physical identifier physically coupled to a tangible object;
correlate the machine-readable data to the corresponding physical identifier stored in a data store;
generate an object profile associated with the physical identifier;
receive digital content and metadata associated with one or more events corresponding to the tangible object;
associate the digital content and the metadata with the object profile;
store the object profile as a structured digital record in the data store;
retrieve the object profile in response to a scan of the machine-readable element of the physical identifier by a user device;
based on the retrieved object profile, identify one or more events associated with the tangible object and map the digital content and the metadata to the identified one or more events;
generate a digital experience presentation based on the digital content and the metadata associated with the object profile;
transmit the digital experience presentation to a user interface of the user device;
wherein physical coupling of the physical identifier to the tangible object enables repeated scanning of the machine-readable element, such that each scan initiates retrieval of the object profile and enables updates of the object profile via receipt and association of digital content and metadata corresponding to one or more events associated with the tangible object,
such that there is an established persistent physical-to-digital linkage between the digital experience presentation and the tangible object.

15. The CPP of claim 14, wherein the machine-readable element further comprises a quick response (QR) code.

16. The CPP of claim 14, wherein the digital content further comprises multimedia content comprising images, video recordings, and audio recordings.

17. The CPP of claim 14, wherein the metadata further comprises temporal data, location data, environmental data, participant data, object identification data, and capture parameter data.

18. The CPP of claim 14, wherein the tangible object further comprises a taxidermy mount.

19. The CPP of claim 14, wherein the operations further comprise:
automatically generate content of the digital experience presentation, wherein the content comprises a multimedia presentation generated by: (i) evaluating metadata associated with the one or more events; (ii) selecting digital content associated with the one or more events based on the evaluated metadata; (iii) and based on the selected digital content, generating the multimedia presentation corresponding to an event-based history of the tangible object.

20. The CPP of claim 14, wherein the digital experience presentation comprises an event-based multimedia narrative based on the object profile, the event-based multimedia narrative comprising a structured sequence of visual, audio, and textual elements that present the one or more events associated with the tangible object together with contextual information derived from associated metadata.
